(19) United States
(12) Patent Application Publication
(10) Pub. No.: US 2026/0045709 A1
(43) Pub. Date: Feb. 12, 2026

(54) ELECTRIC CONNECTION STRUCTURE AND ELECTRONIC DEVICE

(71) Applicant: CANON KABUSHIKI KAISHA, Tokyo (JP)

(72) Inventor: MAKOTO NISHINO, Kanagawa (JP)

(21) Appl. No.: 19/264,595

(22) Filed: Jul. 9, 2025

(30) Foreign Application Priority Data
Aug. 9, 2024 (JP) 2024-134499

(51) Int. Cl. H01R 4/48

(52) U.S. Cl. CPC H01R 4/48

(57) ABSTRACT

An electric connection structure includes a first member having conductivity, and a second member having conductivity and including a first portion and a second portion that is elastically deformable. In a state in which the first member and the second member are not in contact with each other, the second portion and the first portion are separated from each other with a space therebetween, and a minimum distance between the second portion and the first portion is a first distance. In a state in which the first member and the second member are in contact with each other, the second portion is elastically deformed, and the minimum distance between the second portion and the first portion is a second distance smaller than the first distance.

### BACKGROUND

### Field of the Technology

The present disclosure relates to an electric connection structure useful for a casing or the like of an electronic device.

### Description of the Related Art

In various electronic devices such as personal computers and office appliances, for example, stable conduction needs to be secured by, for example, reducing the electrical resistance between electrical contacts between parts such as an exterior cover and a casing. For example, in the case of forming electrical contacts by using plate members having a surface that is warped, twisted, or rough, the contact area can be smaller and thus the electric conduction between parts can deteriorate.

WO 2017/068715 discloses a holder formed from a metal plate and an electric connection method of a liquid crystal module accommodated in the holder. That is, a plate spring portion is formed by providing a slit in the holder formed from a metal plate, and electric connection between the holder and the liquid crystal module is secured by causing a protrusion provided on the plate spring portion to abut a side surface of the liquid crystal module.

According to the method of WO 2017/068715, it is expected that the reliability of the electric connection between the holder and the liquid crystal module is improved by causing the protrusion portion urged by the plate spring to abut the side surface of the liquid crystal module.

However, in the method of WO 2017/068715, a slit is provided in the holder formed from a metal plate to form a plate spring, and there is a possibility that an electromagnetic noise is leaked or radiated through this slit from an electronic device in the holder to the outside.

### SUMMARY

Therefore, there was a need for a technique capable of suppressing leakage and radiation of an electromagnetic noise to the outside while reliably securing electric connection.

According to a first aspect of the present disclosure, an electric connection structure includes a first member having conductivity, and a second member having conductivity and including a first portion and a second portion that is elastically deformable. In a state in which the first member and the second member are not in contact with each other, the second portion and the first portion are separated from each other with a space therebetween, and a minimum distance between the second portion and the first portion is a first distance. In a state in which the first member and the second member are in contact with each other, the second portion is elastically deformed, and the minimum distance between the second portion and the first portion is a second distance smaller than the first distance.

Features of the present disclosure will become apparent from the following description of embodiments with reference to the attached drawings. The following description of embodiments is described by way of example.

### BRIEF DESCRIPTION OF THE DRAWINGS

FIG. 1 is a partially cut-out perspective view for describing an example of a casing of an electronic device according to an embodiment.

FIG. 2 is a transparent view of one of connection mechanisms according to a first embodiment as viewed through from obliquely above.

FIG. 3 is a diagram illustrating a connection mechanism according to the first embodiment in a state in which a lid is detached from a container and thus the lid and the container are separated.

FIG. 4 is a diagram illustrating the connection mechanism according to the first embodiment in a state in which the lid is fastened to the container.

FIG. 5A is a section view of the connection mechanism of the first embodiment taken along a line D-D of FIG. 2 in the state in which the lid is detached from the container and thus the lid and the container are separated.

FIG. 5B is a section view of the connection mechanism of the first embodiment taken along the line D-D of FIG. 2 in the state in which the lid is fastened to the container.

FIG. 6 is a diagram illustrating a connection mechanism according to a second embodiment in a state in which a lid is detached from a container and thus the lid and the container are separated.

FIG. 7 is a diagram illustrating the connection mechanism according to the second embodiment in a state in which the lid is fastened to the container.

FIG. 8A is a section view of the connection mechanism of the second embodiment taken along the line D-D of FIG. 2 in the state in which the lid is detached from the container and thus the lid and the container are separated.

FIG. 8B is a section view of the connection mechanism of the second embodiment taken along the line D-D of FIG. 2 in the state in which the lid is fastened to the container.

FIG. 9 is a schematic diagram for describing a manufacturing method for a second member.

FIG. 10 is a transparent view of one of connection mechanisms according to a third embodiment as viewed through from obliquely above.

FIG. 11 is a section view of the connection mechanism of the third embodiment taken along a line E-E of FIG. 10 in a state in which a lid is fastened to a container.

FIG. 12A is a section view of the connection mechanism of the third embodiment taken along a line D-D of FIG. 10 in a state in which the lid is detached from the container and thus the lid and the container are separated.

FIG. 12B is a section view of the connection mechanism of the third embodiment taken along the line D-D of FIG. 10 in the state in which the lid is fastened to the container.

FIG. 13 is a section view of the connection mechanism of a fourth embodiment taken along a line E-E of FIG. 2 in a state in which a lid is fastened to a container.

FIG. 14A is a section view of the connection mechanism of the fourth embodiment taken along the line D-D of FIG. 2 in a state in which the lid is detached from the container and thus the lid and the container are separated.

FIG. 14B is a section view of the connection mechanism of the fourth embodiment taken along the line D-D of FIG. 2 in the state in which the lid is fastened to the container.

FIG. 15A is a section view of a connection mechanism of a modification example of the fourth embodiment taken along the line D-D of FIG. 2 in a state in which a lid is detached from a container and thus the lid and the container are separated.

FIG. 15B is a section view of the connection mechanism of the modification example of the fourth embodiment taken along the line D-D of FIG. 2 in a state in which the lid is fastened to the container.

FIG. 16A is a section view of a connection mechanism of a modification example of the fourth embodiment taken along the line D-D of FIG. 2 in a state in which a lid is detached from a container and thus the lid and the container are separated.

FIG. 16B is a section view of the connection mechanism of the modification example of the fourth embodiment taken along the line D-D of FIG. 2 in a state in which the lid is fastened to the container.

FIG. 17A is a section view of a connection mechanism of a modification example of the fourth embodiment taken along the line D-D of FIG. 2 in a state in which a lid is detached from a container and thus the lid and the container are separated.

FIG. 17B is a section view of the connection mechanism of the modification example of the fourth embodiment taken along the line D-D of FIG. 2 in a state in which the lid is fastened to the container.

FIG. 18A is a section view of a connection mechanism of a modification example of the fourth embodiment taken along the line D-D of FIG. 2 in a state in which a lid is detached from a container and thus the lid and the container are separated.

FIG. 18B is a section view of the connection mechanism of the modification example of the fourth embodiment taken along the line D-D of FIG. 2 in a state in which the lid is fastened to the container.

FIG. 19A is a section view of a connection mechanism of a modification example of the fourth embodiment taken along the line D-D of FIG. 2 in a state in which a lid is detached from a container and thus the lid and the container are separated.

FIG. 19B is a section view of the connection mechanism of the modification example of the fourth embodiment taken along the line D-D of FIG. 2 in a state in which the lid is fastened to the container.

FIG. 20A is a section view of a connection mechanism of a fifth embodiment taken along the line D-D of FIG. 2 in a state in which a lid is detached from a container and thus the lid and the container are separated.

FIG. 20B is a section view of the connection mechanism of the fifth embodiment taken along the line D-D of FIG. 2 in a state in which the lid is fastened to the container.

FIG. 21A is a section view of a connection mechanism of a reference example in a state in which a lid is detached from a container and thus the lid and the container are separated.

FIG. 21B is a section view of the connection mechanism of the reference example in a state in which the lid is fastened to the container.

FIG. 22A is a diagram illustrating an elliptical cone serving as a modification example of a protrusion portion of a first member.

FIG. 22B is a diagram illustrating a quadrangular prism serving as a modification example of the protrusion portion of the first member.

FIG. 22C is a diagram illustrating a shape serving as a modification example of the protrusion portion of the first member in which part of a plate is peeled up.

FIG. 23A is a diagram illustrating a modification example of a protrusion portion of the fifth embodiment.

FIG. 23B is a diagram illustrating another modification example of the protrusion portion of the fifth embodiment.

FIG. 23C is a diagram illustrating yet another modification example of the protrusion portion of the fifth embodiment.

FIG. 24 is a diagram illustrating an image forming apparatus to which the electric connection structure according to the present disclosure is applicable.

FIG. 25 is a table showing specifications and evaluation results of examples and a reference example.

### DESCRIPTION OF THE EMBODIMENTS

An electric connection structure according to embodiments, an electronic device including the electric connection structure, and the like will be described with reference to drawings. The embodiments and examples shown below are merely exemplifications, and for example, details of the configurations thereof may be appropriately modified by one skilled in the art for implementation within the gist of the present disclosure.

To be noted, in the drawings referred to in the description below, elements denoted by the same reference signs have substantially the same functions unless otherwise described. In the drawings, in the case where a plurality of the same elements are disposed, addition of reference signs and description thereof may be omitted.

In addition, since the drawings may be schematically expressed for the sake of convenience of illustration and description, the shapes, sizes, and layouts of elements illustrated in the drawings do not necessarily strictly match those in the real world.

In addition, in the description below, for example, in the case of describing a +X direction, this indicates a direction indicated by an X-axis arrow in the illustrated coordinate system, and in the case of describing a −X direction, this indicates a direction that is an opposite direction rotated by 180° from the direction indicated by the X-axis arrow in the illustrated coordinate system. In addition, in the case of simply describing an X direction, this indicates a direction parallel to the X axis regardless of whether or not the direction is indicated by the X-axis arrow in the illustration. The same applies to directions other than X.

### First Embodiment

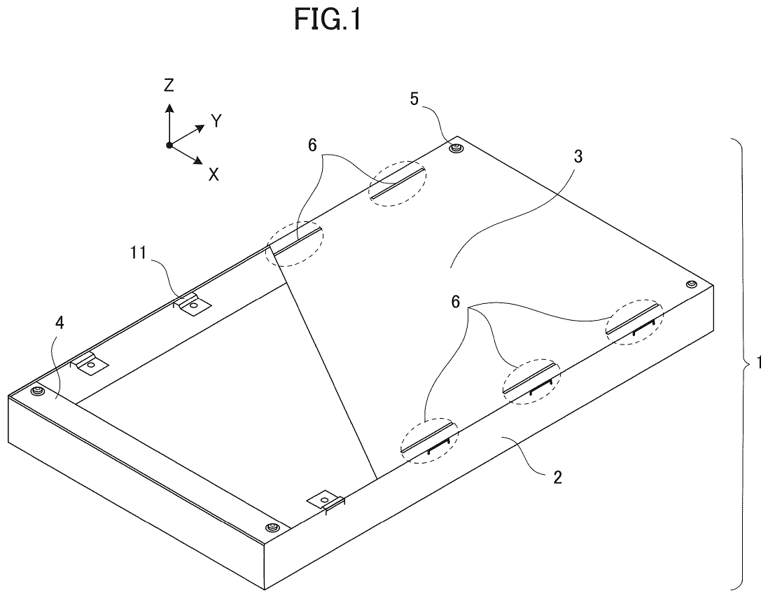

FIG. 1 is a partially cut-out perspective view for describing an example of a casing of an electronic device according to the embodiment. A casing 1 of the electronic device includes a container 2 formed from a metal plate material, and a lid 3 that covers an opening portion of the container 2. The container 2 is provided with an attachment surface 4 formed by bending an edge of the metal plate material. To be noted, FIG. 1 is illustrated with part of the lid 3 cut out such that the attachment surface 4 is visible.

The lid 3 is configured to be attachable to and detachable from the container 2 by using, for example, a screw or the like. In accordance with the type and use of the electronic device, the lid 3 can be detached to perform, for example, replenishment of consumables, replacement of parts, cleaning of the inside of the casing, or inspection of the inside of the casing, and then the lid 3 can be attached again.

When the lid 3 is brought into contact with the attachment surface 4 of the container 2 and fixed thereto at a fastening portion 5 by using a screw or the like, the casing 1 takes a box shape. To facilitate the assembly of the casing 1, a structure in which a cutout is provided in the lid 3, the cutout is fit with a fastening piece such as a screw attached to the container 2 side of the fastening portion 5, the lid 3 is positioned by being moved in the horizontal direction on the attachment surface 4 of the container 2, and thus the lid 3 is fastened is employed.

To suppress a failure caused by static electricity or electromagnetic waves, the container 2 and the lid 3 constituting the casing 1 are each formed from a conductive material such as metal. The materials constituting the container 2 and the lid 3 may be the same or different from each other as long as the material has conductivity.

An electric connection structure is formed to secure electric conduction between the container 2 and the lid 3 such that when one of the container 2 and the lid 3 is electrically grounded, the other is also grounded. As described above, the lid 3 can be repetitively attached to and detached from the container 2, and the electric connection structure is configured such that the electric conduction is easily and reliably established each time. Specifically, a configuration in which when the lid 3 is fastened to the container 2 by fastening the screw disposed at the fastening portion 5, the electric connection between the container 2 and the lid 3 is established in each of a plurality of connection mechanisms 6 provided on the attachment surface 4 is employed. The electric connection structure will be described in detail later.

The metal material constituting the container 2 and the lid 3 of the casing 1 may be an iron material or a copper material having a low electrical resistance, a necessary strength, and an excellent processibility, but may be a metal or an alloy different from these. For example, the container 2 and the lid 3 may be formed by pressing a metal plate material, and the thickness of the plate material may be, for example, 0.4 mm to 1.2 mm from the viewpoint of processibility and mechanical strength. In some cases, the surface of the plate material is treated with a coating film such as zinc plating for the purpose of, for example, maintaining rust resistance. In addition, in some cases, the surface is treated with a resin coating film for maintaining pleasant appearance, and a coating film of a resin material such as polyester, vinyl chloride, urethane, or silicone can be used. To be noted, such a resin coating film generally has a low electrical conductivity, and therefore the resin coating film is not provided at the connection mechanism 6.

### Electric Connection Structure

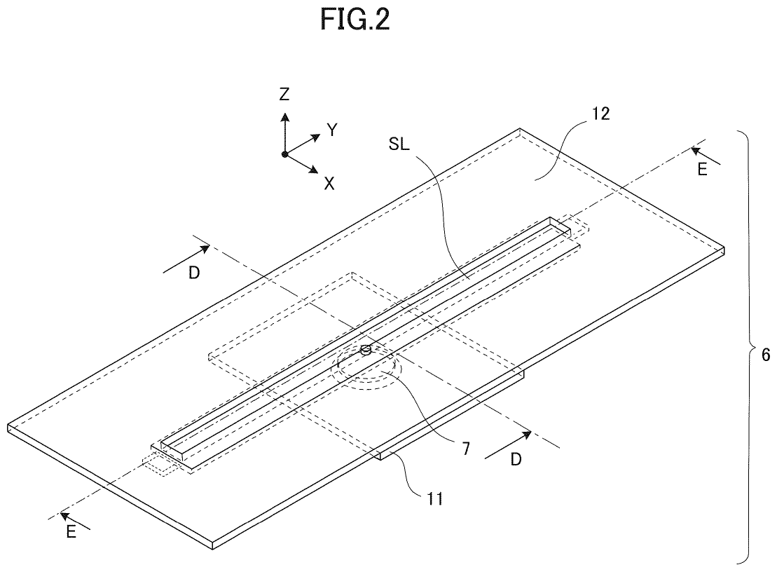

An electric connection structure for establishing electric conduction between the container 2 and the lid 3 will be described. The electric connection structure includes a plurality of connection mechanisms 6 as illustrated in FIG. 1. FIG. 2 is a transparent view in which one of the connection mechanisms 6 is viewed through from obliquely above for describing the configuration of the connection mechanism 6.

The connection mechanism 6 includes a first member 11 that is part of the container 2 and that has a plate shape, and a second member 12 that is part of the lid 3 and that has a plate shape. The first member 11 includes a protrusion portion 7 protruding in the +Z direction. The second member 12 is provided with an opening portion SL that is an opening of a slit shape extending in the Y direction.

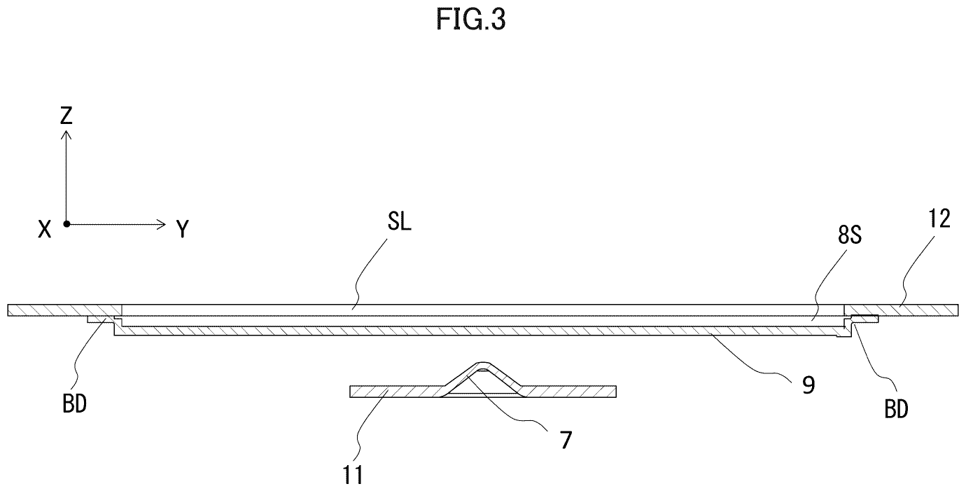

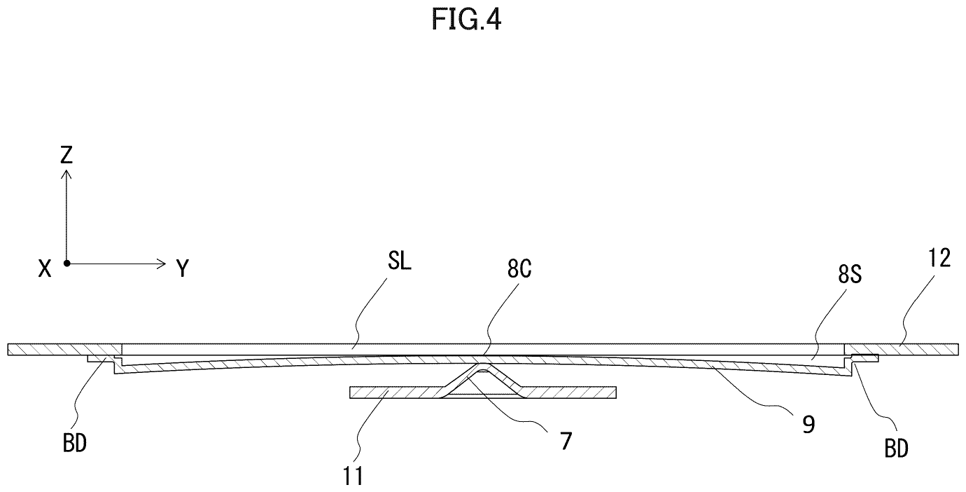

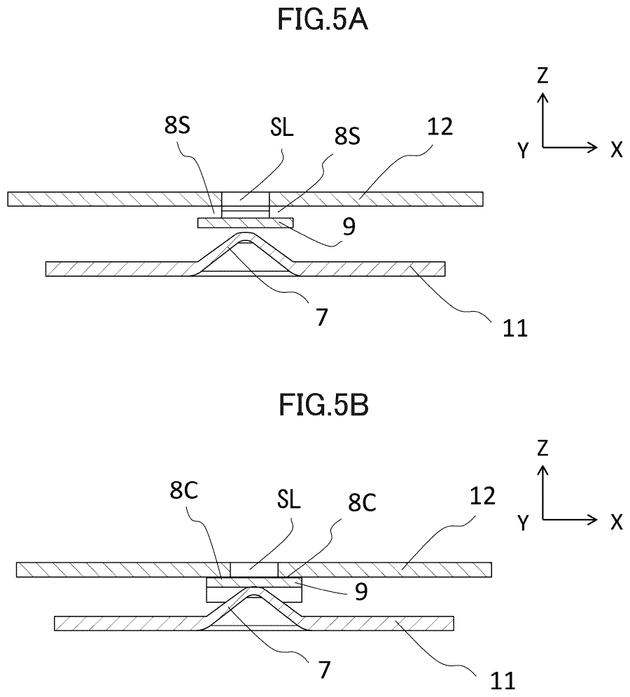

FIGS. 3 and 4 are each a section view of the connection mechanism 6 taken along a line E-E of FIG. 2. FIG. 3 illustrates the connection mechanism 6 in a state in which the lid 3 is detached from the container 2 and the two are separated, and FIG. 4 illustrates the connection mechanism 6 in a state in which the screw disposed at the fastening portion 5 is tightened and thus the lid 3 is fastened to the container 2. FIGS. 5A and 5B are each a section view of the connection mechanism 6 taken along a line D-D of FIG. 2. FIG. 5A illustrates the connection mechanism 6 in the state in which the lid 3 is detached from the container 2 and the two are separated, and FIG. 5B illustrates the connection mechanism 6 in the state in which the screw disposed at the fastening portion 5 is tightened and thus the lid 3 is fastened to the container 2.

As illustrated in FIGS. 3 and 4, the second member 12 having conductivity is provided with a conductive elastic member 9 extending in the longitudinal direction of the opening portion SL. In the second member 12 (second member), the elastic member 9 may be referred to as a second portion, and a portion other than the elastic member 9 may be referred to as a first portion.

The elastic member 9 has a width larger than the opening portion SL in the X direction (short-side direction of the opening portion SL) and the Y direction (longitudinal direction of the opening portion SL), and is disposed to cover the opening portion SL from below in plan view from the Z direction. In other words, the elastic member 9 has a larger area than the opening portion SL, and the casing 1 has such a structure that the inside thereof is not visible as a result of being blocked by the elastic member 9 when the opening portion SL is viewed from the Z direction.

At end portions BD of the elastic member 9 in the longitudinal direction, the elastic member 9 is fixed to the second member 12, and is electrically connected to the second member 12 (that is, the lid 3). The end portions BD of the elastic member 9 may be fixed to the second member 12 by welding, glued to the second member 12 by a conductive adhesive, or may be joined to the second member 12 by a method such as crimping using plastic processing. The thickness of the elastic member 9 may be equal to or smaller than the thickness of the second member 12.

A protrusion portion 7 included in the first member 11 is a conductive rigid body, is mechanically fixed to the first member 11 (that is, the container 2), and is also electrically connected to the first member 11 (that is, the container 2) having conductivity.

As illustrated in FIGS. 3 and 5A, in a state in which the lid 3 is detached from the container 2 and the two are separated, the protrusion portion 7 is separated from the elastic member 9, and no electric conduction is established between the lid 3 and the container 2. In contrast, in a state in which the screw disposed at the fastening portion 5 is tightened and the lid 3 is fastened to the container 2, that is, in a state in which a surface of the first member 11 and a surface of the second member 12 are fastened together in contact with each other, as illustrated in FIGS. 4 and 5B, the protrusion portion 7 urges the elastic member 9 in the +Z direction, thus the elastic member 9 is elastically deformed, and the two are fixed to each other in a state in which an appropriate contact force is acting therebetween. Therefore, an electric conduction path is reliably formed between the lid 3 and the container 2.

Here, according to the present embodiment, when fastening the lid 3 to the container 2, the elastic member 9 is elastically deformed by being urged by the protrusion portion 7, and therefore a path through which an electromagnetic noise is leaked or radiated to the outside can be narrowed. That is, according to the present embodiment, an electric connection structure capable of suppressing leakage or radiation of an electromagnetic noise to the outside is formed while reliably securing electric connection.

As illustrated in FIG. 5A, in a state in which the protrusion portion 7 is separated from the elastic member 9, the second member 12 is separated from end portions of the elastic member 9 in the short-side direction, and there is a space 8S therebetween. As illustrated in FIG. 3, this space 8S is present in the entire region of the opening portion SL in the longitudinal direction. The space 8S communicates with the opening portion SL, and can serve as a path through which an electromagnetic noise is leaked or radiated from the inside of the casing 1 to the outside.

However, according to the present embodiment, when fastening the lid 3 to the container 2, the elastic member 9 is urged by the protrusion portion 7 to be elastically deformed in the +Z direction. As a result of this, in the vicinity of the protrusion portion 7, as illustrated in FIG. 5B, end portions of the elastic member 9 in the short-side direction abut the second member 12 to form contact portions 8C, and the space 8S is no longer present. As viewed in the longitudinal direction of the elastic member 9, as illustrated in FIG. 4, the space 8S still remains in the vicinity of the end portions BD, but as a result of the elastic deformation of the elastic member 9, the space 8S is greatly reduced in size near the contact portions 8C. As described above, the space 8S communicating with the opening portion SL and possibly serving as a path through which an electromagnetic noise is leaked or radiated to the outside from the inside of the casing 1 is greatly reduced in size in a state in which an electric conduction path is established between the lid 3 and the container 2.

The length of the space 8S in the Z direction (that is, the distance between the second member 12 and the elastic member 9) in a state in which the protrusion portion 7 is not urging the elastic member 9 may be equal to or less than a distance by which the elastic member 9 is urged by the protrusion portion 7 in the +Z direction when fastening the lid 3 to the container 2. This is because if the length of the space 8S in the Z direction is larger than this, there is a possibility that the contact portions 8C are not formed even right above the protrusion portion 7 when the protrusion portion 7 urges the elastic member 9, and the space 8S remains. However, when the elastic member 9 is elastically deformed in the +Z direction even slightly by being urged by the protrusion portion 7, the minimum distance between the elastic member 9 and the second member 12 becomes smaller. Since the space 8S is reduced in size even if the contact portions 8C are not formed, the effect of suppressing leakage or radiation of an electromagnetic noise can be obtained to some extent.

If the width of the elastic member 9 in the short-side direction (X direction) is set to be equal to or larger than a double of the thickness thereof, high shape precision (for example, surface precision) is more likely to be secured when manufacturing the elastic member 9. However, if the width is set to be too large, the elastic member 9 becomes less likely to be elastically deformed when urged by the protrusion portion 7. Therefore, the width of the elastic member 9 in the short-side direction (X direction) may be set to be about a double of the thickness thereof. In addition, the length of the elastic member 9 in the longitudinal direction (Y direction) may be 5 times or more of the thickness thereof. This is because if the length is too small, the elastic member 9 is less likely to be elastically deformed in the +Z direction when urged by the protrusion portion 7.

In the present embodiment, the area of the elastic member 9 in plan view is larger than the area of the opening portion SL, and the casing 1 has such a structure that the inside thereof is not visible as a result of being covered by the elastic member 9 when the opening portion SL is viewed from the Z direction. Therefore, the electromagnetic noise that propagates in the +Z direction from the inside of the container 2 toward the opening portion SL is shielded by the conductive elastic member 9. In addition, since the space 8S between the elastic member 9 and the second member 12 is narrowed by the elastic deformation of the elastic member 9, the electromagnetic noise leaking to the outside via the opening portion SL by passing through the space 8S between the elastic member 9 and the second member 12 is suppressed greatly.

The connection mechanism 6 is disposed at a plurality of portions in the casing 1 as illustrated in FIG. 1, and therefore the reliability of the electric connection between the lid 3 and the container 2 is secured. While repeating the attachment and detachment of the lid 3 and the container 2, for example, even if the lid 3 is deformed to some extent, the elastic member 9 is elastically deformed while securing electric connection at a plurality of portions, and therefore leakage of the electromagnetic noise is suppressed.

### Second Embodiment

Embodiments of the present disclosure are not limited to the first embodiment described above. A second embodiment having an electric connection structure different from the first embodiment will be described below. To be noted, description of matter common to the first embodiment will be simplified or omitted. Description of the casing of the electronic device is substantially the same as in the first embodiment described with reference to FIG. 1.

### Electric Connection Structure

The electric connection structure for securing electric conduction between the container 2 and the lid 3 will be described. The electric connection structure includes a plurality of connection mechanisms 6 as illustrated in FIG. 1. The electric connection mechanism according to the present embodiment has a similar configuration to FIG. 2 referred to in the description of the first embodiment in transparent view from obliquely above. However, the width in the short-side direction, the shape of the end portion, and the formation method of the elastic member 9 are different from the first embodiment. The connection mechanism 6 includes the first member 11 that is part of the container 2 and that has a plate shape, and the second member 12 that is part of the lid 3 and that has a plate shape. The first member 11 includes the protrusion portion 7 protruding in the +Z direction. The second member 12 is provided with the opening portion SL that is an opening of a slit shape extending in the Y direction.

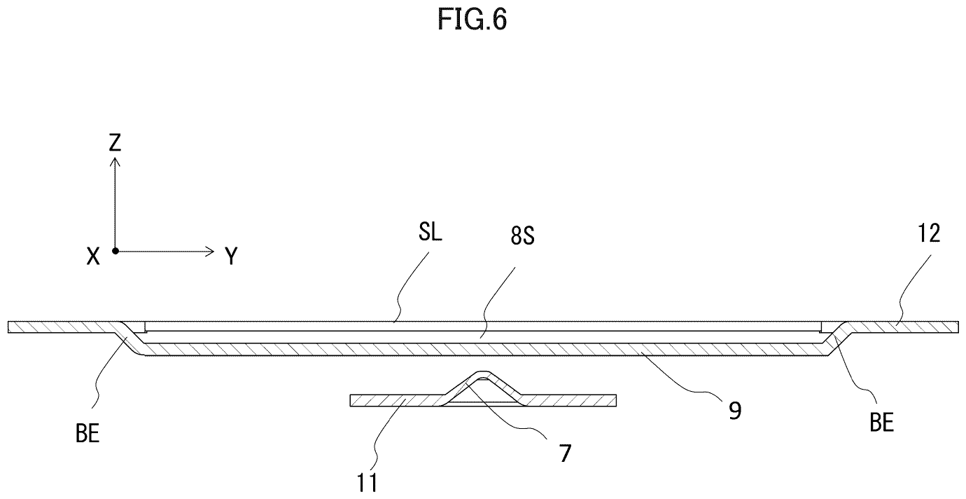

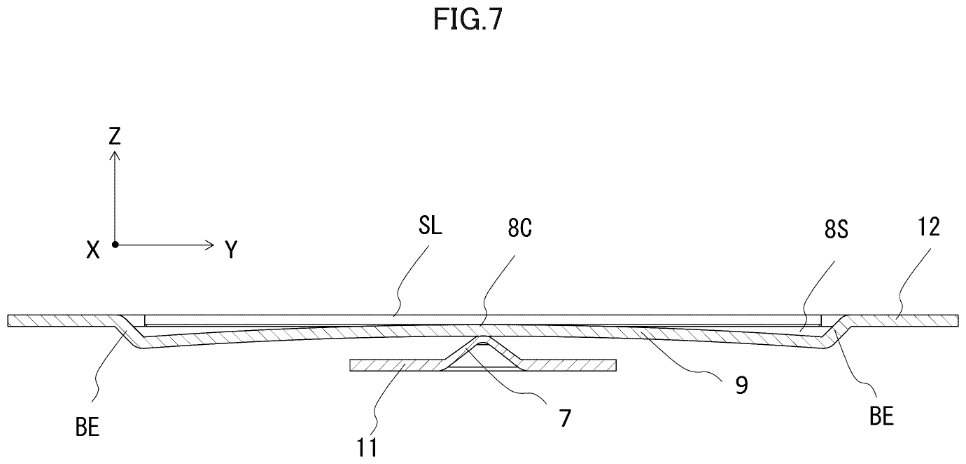

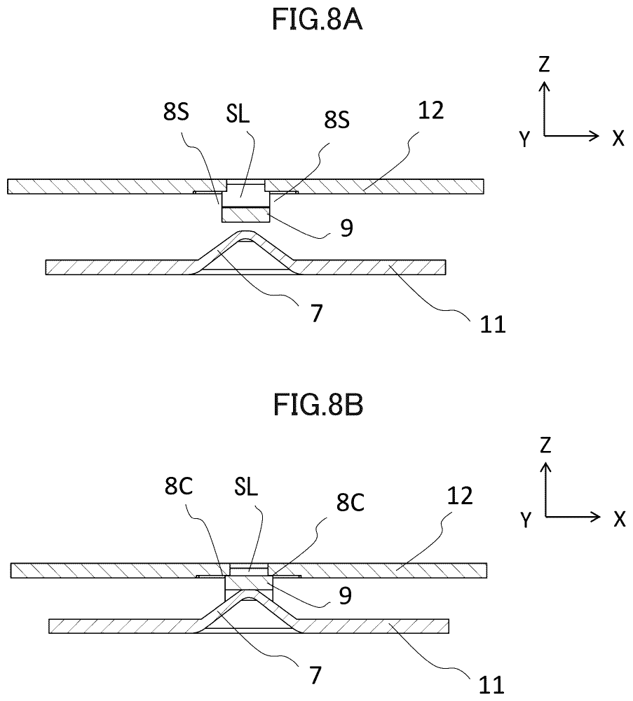

FIGS. 6 and 7 are each a section view of the connection mechanism 6 taken along the line E-E of FIG. 2. FIG. 6 illustrates the connection mechanism 6 in a state in which the lid 3 is detached from the container 2 and the two are separated, and FIG. 7 illustrates the connection mechanism 6 in a state in which the screw disposed at the fastening portion 5 is tightened and thus the lid 3 is fastened to the container 2. FIGS. 8A and 8B are each a section view of the connection mechanism 6 taken along the line D-D of FIG. 2. FIG. 8A illustrates the connection mechanism 6 in the state in which the lid 3 is detached from the container 2 and the two are separated, and FIG. 8B illustrates the connection mechanism 6 in the state in which the screw disposed at the fastening portion 5 is tightened and thus the lid 3 is fastened to the container 2.

As illustrated in FIGS. 6 and 7, the second member 12 having conductivity is provided with a conductive elastic member 9 extending in the longitudinal direction of the opening portion SL. In the second member 12 (second member), the elastic member 9 may be referred to as a second portion, and a portion other than the elastic member 9 may be referred to as a first portion.

The elastic member 9 has a width larger than the opening portion SL in the X direction (short-side direction of the opening portion SL) and the Y direction (longitudinal direction of the opening portion SL), and is disposed to cover the opening portion SL from below in plan view from the Z direction. In other words, the elastic member 9 has a larger area than the opening portion SL, and the casing 1 has such a structure than the inside thereof is not visible as a result of being blocked by the elastic member 9 when the opening portion SL is viewed from the Z direction. At connecting portions BE at ends of the elastic member 9 in the longitudinal direction, the elastic member 9 is connected to the second member 12, and is also electrically connected to the second member 12 (that is, the lid 3).

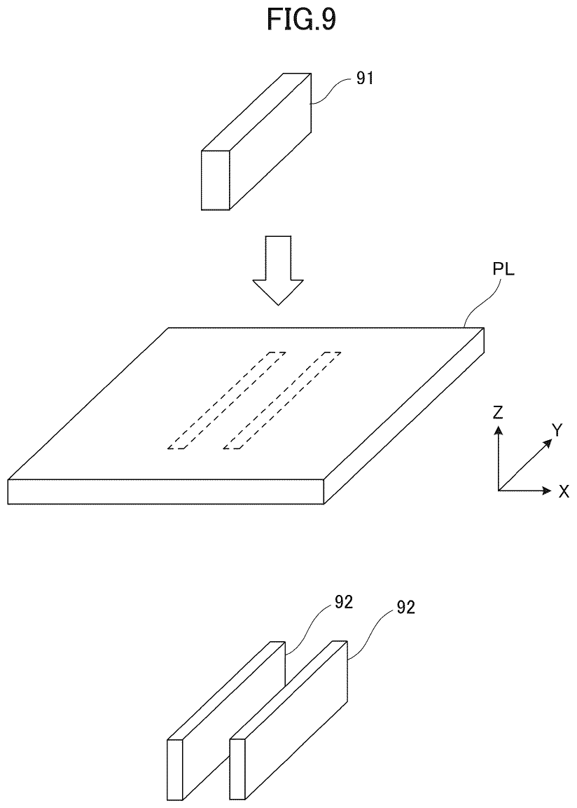

In the present embodiment, a hole punching process is performed on a single metal plate by using a die, and thus the opening portion SL and a portion to be the elastic member 9 are integrally formed. As illustrated in FIG. 9, potions indicated by dot lines in a metal plate PL are supported by a pair of dies 92, and a hole punching process is performed by using a puncher 91. As a result of the hole punching process, the opening portion SL is formed, and thus the second member 12 integrated with the elastic member 9 is formed. As illustrated in FIG. 8A, at portions of the second member 12 on respective sides in the short-side direction (X direction) of the opening portion SL, recesses are respectively formed at positions supported by the pair of dies 92, and thus the thickness of the second member 12 is smaller at these portions. The metal portion formed by the punching by the puncher 91 serves as the elastic member 9. The metal material at the portion on the side of the opening portion SL where the thickness is smaller is moved to protrude inward with respect to the opening portion SL by plastic deformation, and therefore the width of the opening portion SL in the X direction is smaller than the width of the elastic member 9 formed by the punching in the X direction. The thickness of the portion on the side of the opening portion SL can be 50% or more and 90% or less of the thickness of the second member 12.

In addition, as illustrated in FIG. 6, the portion to be the elastic member 9 is not completely cut off from the plate PL in the hole punching process by the puncher 91, and end portions thereof in the longitudinal direction (Y direction) that are plastically deformed are connected to the second member 12 as connecting portions BE. The connecting portions BE interconnecting the second member 12 and the elastic member 9 are bent into a step shape, and each constitute an inclined surface that is 30° or more and 60° or less with respect to the main surface of the second member 12.

In the present embodiment, since the second member 12 and the elastic member 9 are formed from one metal plate PL, each have substantially the same thickness. To be noted, although the hole punching process is performed by using the pair of dies 92 and the puncher 91 in the example illustrated in FIG. 9, for example, the hole punching process may be performed by using one die and a puncher.

Similarly to the first embodiment, also in the present embodiment, the protrusion portion 7 included in the first member 11 is a conductive rigid body, is mechanically fixed to the first member 11 (that is, the container 2), and is also electrically connected to the first member 11 (that is, the container 2) having conductivity.

As illustrated in FIGS. 6 and 8A, in a state in which the lid 3 is detached from the container 2 and the two are separated, the protrusion portion 7 is separated from the elastic member 9, and no electric conduction is established between the lid 3 and the container 2. In contrast, in a state in which the screw disposed at the fastening portion 5 is tightened and the lid 3 is fastened to the container 2, as illustrated in FIGS. 7 and 8B, the protrusion portion 7 urges the elastic member 9 in the +Z direction, thus the elastic member 9 is elastically deformed, and the two are fixed to each other in a state in which an appropriate contact force is acting therebetween. Therefore, an electric conduction path is reliably formed between the lid 3 and the container 2.

Also, according to the present embodiment, when fastening the lid 3 to the container 2, the elastic member 9 is elastically deformed by being urged by the protrusion portion 7, and therefore a path through which an electromagnetic noise is leaked or radiated to the outside can be narrowed. That is, according to the present embodiment, an electric connection structure capable of suppressing leakage or radiation of an electromagnetic noise to the outside is formed while reliably securing electric connection.

As illustrated in FIG. 8A, in a state in which the protrusion portion 7 is separated from the elastic member 9, the second member 12 is separated from end portions of the elastic member 9 in the short-side direction, and there is the space 8S therebetween. As illustrated in FIG. 6, this space 8S is present in the entire region of the opening portion SL in the longitudinal direction. The space 8S communicates with the opening portion SL, and can serve as a path through which an electromagnetic noise is leaked or radiated from the inside of the casing 1 to the outside.

However, according to the present embodiment, when fastening the lid 3 to the container 2, the elastic member 9 is urged by the protrusion portion 7 to be elastically deformed in the +Z direction. As a result of this, in the vicinity of the protrusion portion 7, as illustrated in FIG. 8B, end portions of the elastic member 9 in the short-side direction abut the second member 12 to form contact portions 8C, and the space 8S is no longer present. As viewed in the longitudinal direction of the elastic member 9, as illustrated in FIG. 7, the space 8S still remains in the vicinity of the end portions BD, but as a result of the elastic deformation of the elastic member 9, the space 8S is greatly reduced in size near the contact portions 8C. As described above, the space 8S communicating with the opening portion SL and possibly serving as a path through which an electromagnetic noise is leaked or radiated to the outside is greatly reduced in size in a state in which an electric conduction path is established between the lid 3 and the container 2.

The length of the space 8S in the Z direction (that is, the distance between the second member 12 and the elastic member 9) in a state in which the protrusion portion 7 is not urging the elastic member 9 may be equal to or less than a distance by which the elastic member 9 is urged by the protrusion portion 7 in the +Z direction when fastening the lid 3 to the container 2. This is because if the length of the space 8S in the Z direction is larger than this, there is a possibility that the contact portions 8C are not formed even right above the protrusion portion 7 when the protrusion portion 7 urges the elastic member 9, and the space 8S remains. However, when the elastic member 9 is elastically deformed in the +Z direction even slightly by being urged by the protrusion portion 7, the minimum distance between the elastic member 9 and the second member 12 becomes smaller. Since the space 8S is reduced in size even if the contact portions 8C are not formed, the effect of suppressing leakage or radiation of an electromagnetic noise can be obtained to some extent.

If the width of the elastic member 9 in the short-side direction (X direction) is set to be equal to or larger than a double of the thickness thereof, high shape precision (for example, surface precision) is more likely to be secured when manufacturing the elastic member 9. However, if the width is set to be too large, the elastic member 9 becomes less likely to be elastically deformed when urged by the protrusion portion 7. Therefore, the width of the elastic member 9 in the short-side direction (X direction) may be set to be about a double of the thickness thereof. In addition, the length of the elastic member 9 in the longitudinal direction (Y direction) may be 5 times or more of the thickness thereof. This is because if the length is too small, the elastic member 9 is less likely to be elastically deformed in the +Z direction when urged by the protrusion portion 7.

In the present embodiment, the area of the elastic member 9 in plan view is larger than the area of the opening portion SL, and the casing 1 has such a structure that the inside thereof is not visible as a result of being covered by the elastic member 9 when the opening portion SL is viewed from the Z direction. Therefore, the electromagnetic noise that propagates in the +Z direction from the inside of the container 2 toward the opening portion SL is shielded by the conductive elastic member 9. In addition, since the space 8S between the elastic member 9 and the second member 12 is narrowed by the elastic deformation of the elastic member 9, the electromagnetic noise leaking to the outside by bypassing the elastic member 9 to the opening portion SL through the space 8S is suppressed greatly.

The connection mechanism 6 is disposed at a plurality of portions in the casing 1 as illustrated in FIG. 1, and therefore the reliability of the electric connection between the lid 3 and the container 2 is secured. While repeating the attachment and detachment of the lid 3 and the container 2, for example, even if the lid 3 is deformed to some extent, the elastic member 9 is elastically deformed while securing electric connection at a plurality of portions, and therefore leakage of the electromagnetic noise is suppressed.

### Third Embodiment

Embodiments of the present disclosure are not limited to the embodiments described above. A third embodiment having a different electric connection structure will be described below. To be noted, description of matter common to the first embodiment will be simplified or omitted. Description of the casing of the electronic device is substantially the same as in the first embodiment described with reference to FIG. 1.

### Electric Connection Structure

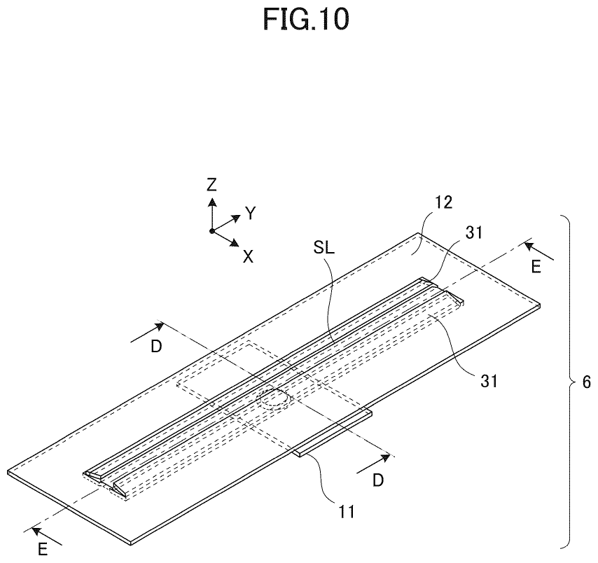

The electric connection structure for securing electric conduction between the container 2 and the lid 3 will be described. The electric connection structure includes a plurality of connection mechanisms 6 as illustrated in FIG. 1. FIG. 10 is a transparent view in which one of the connection mechanisms 6 is viewed through from obliquely above for describing the configuration of the connection mechanism 6. The structure of the opening portion SL and the elastic member 9 of the second member 12 is different from the first embodiment. The connection mechanism 6 includes the first member 11 that is part of the container 2 and that has a plate shape, and the second member 12 that is part of the lid 3 and that has a plate shape. The first member 11 includes the protrusion portion 7 protruding in the +Z direction. The second member 12 is provided with the opening portion SL that is an opening of a slit shape extending in the Y direction.

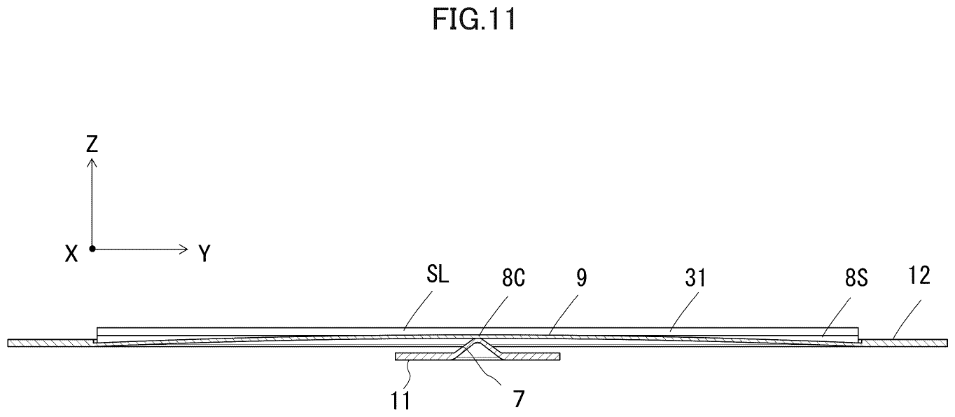

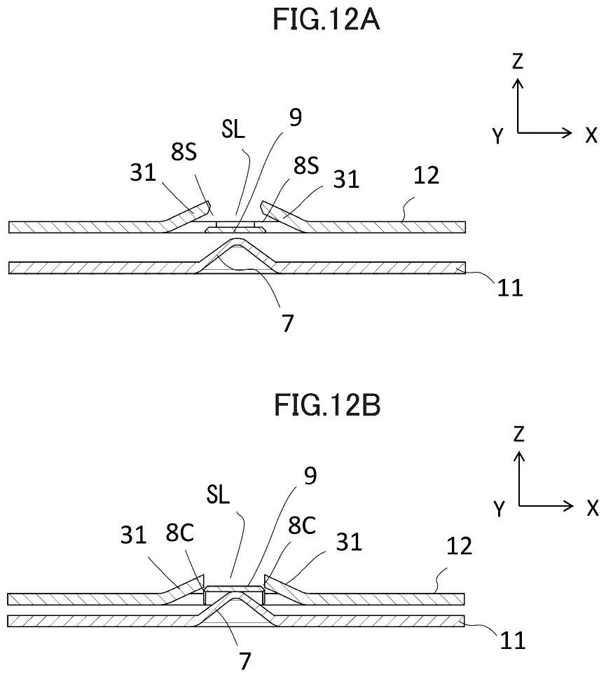

FIG. 11 is a section view of the connection mechanism 6 taken along a line E-E of FIG. 10, and illustrates the connection mechanism 6 in a state in which the screw disposed at the fastening portion 5 is tightened and thus the lid 3 is fastened to the container 2. FIGS. 12A and 12B are each a section view of the connection mechanism 6 taken along a line D-D of FIG. 10. FIG. 12A illustrates the connection mechanism 6 in the state in which the lid 3 is detached from the container 2 and the two are separated, and FIG. 12B illustrates the connection mechanism 6 in the state in which the screw disposed at the fastening portion 5 is tightened and thus the lid 3 is fastened to the container 2.

As illustrated in FIGS. 10 and 12A, the second member 12 having conductivity has a bent shape 31 at an obtuse angle on each side of the opening portion SL that is an opening having a slit shape extending in the Y direction. The bent shape 31 protrudes in a direction opposite to the first member 11 (that is, the +Z direction) at an angle of, for example, 150° or more and 170° or less with respect to the main surface of the second member 12. The width of the bent shape 31 in the X direction may be equal to or larger than a triple of the thickness of the second member 12.

In addition, as illustrated in FIG. 11, the second member 12 is provided with the conductive elastic member 9 extending in the longitudinal direction of the opening portion SL (Y direction). In the second member 12 (second member), the elastic member 9 may be referred to as a second portion, and a portion other than the elastic member 9 may be referred to as a first portion.

At an end portion of the elastic member 9 in the longitudinal direction, the elastic member 9 is fixed to the second member 12, and is also electrically connected to the second member 12 (that is, the lid 3). The thickness of the elastic member 9 may be set to 50% or more and 90% or less of the thickness of the second member 12. This is because if the thickness of the elastic member 9 is less than 50% of the thickness of the second member 12, the strength of the connecting portion between the elastic member 9 and the second member 12 can be insufficient. If the width of the elastic member 9 in the short-side direction (X direction) is set to be equal to or larger than a double of the thickness of the second member 12, high shape precision (for example, surface precision) is more likely to be secured when manufacturing the elastic member 9. In addition, the length of the elastic member 9 in the longitudinal direction (Y direction) may be 5 times or more of the thickness of the second member 12. This is because if the length is too small, the elastic member 9 is less likely to be elastically deformed in the +Z direction when urged by the protrusion portion 7.

As illustrated in FIG. 12A, in a state in which the lid 3 is detached from the container 2 and the two are separated, the protrusion portion 7 is separated from the elastic member 9, and no electric conduction path is formed between the lid 3 and the container 2. In contrast, in a state in which the screw disposed at the fastening portion 5 is tightened and the lid 3 is fastened to the container 2, as illustrated in FIGS. 11 and 12B, the protrusion portion 7 urges the elastic member 9 in the +Z direction, thus the elastic member 9 is elastically deformed, and the two are fixed to each other in a state in which an appropriate contact force is acting therebetween. Therefore, an electric conduction path is reliably formed between the lid 3 and the container 2.

Here, according to the present embodiment, when fastening the lid 3 to the container 2, the elastic member 9 is elastically deformed by being urged by the protrusion portion 7, and therefore a path through which an electromagnetic noise is leaked or radiated to the outside can be narrowed. That is, according to the present embodiment, an electric connection structure capable of suppressing leakage or radiation of an electromagnetic noise to the outside is formed while reliably securing electric connection.

As illustrated in FIG. 12A, in a state in which the protrusion portion 7 is separated from the elastic member 9, the second member 12 is separated from end portions of the elastic member 9 in the short-side direction, and there is the space 8S therebetween. This space 8S is present in the entire region of the opening portion SL in the longitudinal direction. The space 8S communicates with the opening portion SL, and can serve as a path through which an electromagnetic noise is leaked or radiated from the inside of the casing 1 to the outside.

However, according to the present embodiment, when fastening the lid 3 to the container 2, the elastic member 9 is urged by the protrusion portion 7 to be elastically deformed in the +Z direction. As a result of this, in the vicinity of the protrusion portion 7, as illustrated in FIG. 12B, end portions of the elastic member 9 in the short-side direction abuts the second member 12 to form the contact portions 8C, and the space 8S is no longer present. As viewed in the longitudinal direction of the elastic member 9, as illustrated in FIG. 11, the space 8S still remains in the vicinity of the end portions, but as a result of the elastic deformation of the elastic member 9, the space 8S is greatly reduced in size near the contact portions 8C. As described above, the space 8S communicating with the opening portion SL and possibly serving as a path through which an electromagnetic noise is leaked or radiated to the outside from the inside of the casing 1 is greatly reduced in size in a state in which an electric conduction path is established between the lid 3 and the container 2.

The length of the space 8S in the Z direction (that is, the distance between the second member 12 and the elastic member 9) in a state in which the protrusion portion 7 is not urging the elastic member 9 may be equal to or less than a distance by which the elastic member 9 is urged by the protrusion portion 7 in the +Z direction when fastening the lid 3 to the container 2. This is because if the length of the space 8S in the Z direction is larger than this, there is a possibility that the contact portions 8C are not formed even right above the protrusion portion 7 when the protrusion portion 7 urges the elastic member 9, and the space 8S remains. However, when the elastic member 9 is elastically deformed in the +Z direction even slightly by being urged by the protrusion portion 7, the minimum distance between the elastic member 9 and the second member 12 becomes smaller. Since the space 8S is reduced in size even if the contact portions 8C are not formed, the effect of suppressing leakage or radiation of an electromagnetic noise can be obtained to some extent.

In the present embodiment, the area of the elastic member 9 has a larger area than the opening portion SL, and the casing 1 has such a structure that the inside thereof is not visible as a result of being covered by the elastic member 9 when the opening portion SL is viewed from the Z direction. Therefore, the electromagnetic noise that propagates in the +Z direction from the inside of the container 2 toward the opening portion SL is shielded by the conductive elastic member 9. In addition, since the space 8S between the elastic member 9 and the second member 12 is narrowed by the elastic deformation of the elastic member 9, the electromagnetic noise leaking to the outside by bypassing the elastic member 9 to the opening portion SL through the space 8S is suppressed greatly.

The connection mechanism 6 is disposed at a plurality of portions in the casing 1 as illustrated in FIG. 1, and therefore the reliability of the electric connection between the lid 3 and the container 2 is secured. While repeating the attachment and detachment of the lid 3 and the container 2, for example, even if the lid 3 is deformed to some extent, the elastic member 9 is elastically deformed while securing electric connection at a plurality of portions, and therefore leakage of the electromagnetic noise is suppressed.

### Fourth Embodiment

Embodiments of the present disclosure are not limited to the embodiments described above. A fourth embodiment having a different electric connection structure will be described below. To be noted, description of matter common to the first embodiment will be simplified or omitted. Description of the casing of the electronic device is substantially the same as in the first embodiment described with reference to FIG. 1.

### Electric Connection Structure

The electric connection structure for securing electric conduction between the container 2 and the lid 3 will be described. The electric connection structure includes a plurality of connection mechanisms 6 as illustrated in FIG. 1. The electric connection mechanism according to the present embodiment has a similar configuration to FIG. 2 referred to in the description of the first embodiment in transparent view from obliquely above. However, the shape and formation method of the elastic member 9 are different from the first embodiment. The connection mechanism 6 includes the first member 11 that is part of the container 2 and that has a plate shape, and the second member 12 that is part of the lid 3 and that has a plate shape. The first member 11 includes the protrusion portion 7 protruding in the +Z direction.

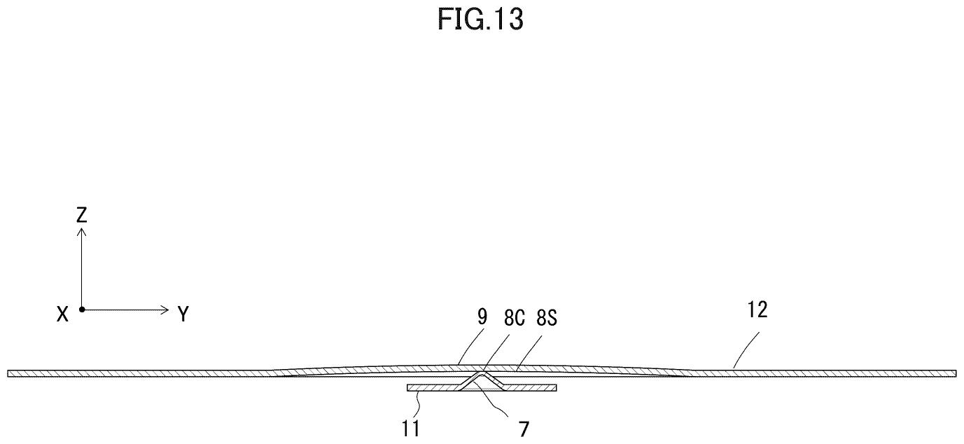

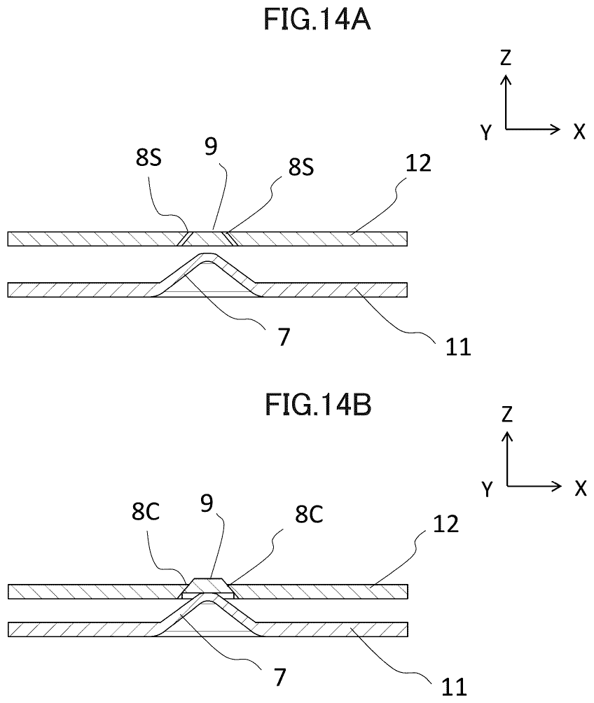

FIG. 13 is a section view of the connection mechanism 6 taken along the line E-E of FIG. 2, and illustrates the connection mechanism 6 in a state in which the screw disposed at the fastening portion 5 is tightened and thus the lid 3 is fastened to the container 2. FIGS. 14A and 14B are each a section view of the connection mechanism 6 taken along the line D-D of FIG. 2. FIG. 14A illustrates the connection mechanism 6 in the state in which the lid 3 is detached from the container 2 and the two are separated, and FIG. 14B illustrates the connection mechanism 6 in the state in which the screw disposed at the fastening portion 5 is tightened and thus the lid 3 is fastened to the container 2.

As illustrated in FIG. 13 the second member 12 having conductivity is provided with a conductive elastic member 9 extending in the longitudinal direction thereof. In the second member 12, the elastic member 9 may be referred to as a second portion, and a portion other than the elastic member 9 may be referred to as a first portion.

As illustrated in FIG. 14A, in the present embodiment, spaces 8S that are each a slit-shaped through hole inclined with respect to the main surface are formed in a metal plate that is a base material of the second member 12, and thus the elastic member 9 that is elastically deformable is defined. The space 8S is a space inclined with respect to the thickness direction of the second member 12. In FIG. 14A, the sectional shape of the elastic member 9 is a trapezoidal shape having a top base shorter than a bottom base. In plan view of the second member 12, the spaces 8S that are each a through hole can be observed as two stripes extending in the Y direction. The space 8S that is a through hole may be inclined by 45° or more and 60° or less with respect to the main surface of the second member 12.

As illustrated in FIG. 14A, in a state in which the lid 3 is detached from the container 2 and the two are separated, the protrusion portion 7 is separated from the elastic member 9, and no electric conduction is established between the lid 3 and the container 2. In contrast, in a state in which the screw disposed at the fastening portion 5 is tightened and the lid 3 is fastened to the container 2, as illustrated in FIG. 14B, the protrusion portion 7 urges the elastic member 9 in the +Z direction, thus the elastic member 9 is elastically deformed, and the two are fixed to each other in a state in which an appropriate contact force is acting therebetween. Therefore, an electric conduction path is reliably formed between the lid 3 and the container 2.

Also, according to the present embodiment, when fastening the lid 3 to the container 2, the elastic member 9 is elastically deformed by being urged by the protrusion portion 7, and therefore a path through which an electromagnetic noise is leaked or radiated to the outside can be narrowed. That is, according to the present embodiment, an electric connection structure capable of suppressing leakage or radiation of an electromagnetic noise to the outside is formed while reliably securing electric connection.

As illustrated in FIG. 14A, in a state in which the protrusion portion 7 is separated from the elastic member 9, the second member 12 is separated from end portions of the elastic member 9 in the short-side direction, and there are the spaces 8S therebetween. The spaces 8S are present in the entire region of the elastic member 9 in the longitudinal direction. The spaces 8S can serve as a path through which an electromagnetic noise is leaked or radiated from the inside of the casing 1 to the outside.

However, according to the present embodiment, when fastening the lid 3 to the container 2, the elastic member 9 is urged by the protrusion portion 7 to be elastically deformed in the +Z direction. As a result of this, in the vicinity of the protrusion portion 7, as illustrated in FIG. 14B, end portions of the elastic member 9 in the short-side direction abut the second member 12 to form contact portions 8C, and the spaces 8S are no longer present. As viewed in the longitudinal direction of the elastic member 9, as illustrated in FIG. 13, the spaces 8S still remain in the vicinity of the end portions, but as a result of the elastic deformation of the elastic member 9, the spaces 8S are greatly reduced in size near the contact portions 8C. As described above, the spaces 8S possibly serving as a path through which an electromagnetic noise is leaked or radiated to the outside from the inside of the casing 1 is greatly reduced in size in a state in which an electric conduction path is established between the lid 3 and the container 2.

The length of the space 8S in the Z direction (that is, the distance between the second member 12 and the elastic member 9) in a state in which the protrusion portion 7 is not urging the elastic member 9 may be equal to or less than a distance by which the elastic member 9 is urged by the protrusion portion 7 in the +Z direction when fastening the lid 3 to the container 2. This is because if the length of the space 8S in the Z direction is larger than this, there is a possibility that the contact portions 8C are not formed even right above the protrusion portion 7 when the protrusion portion 7 urges the elastic member 9, and the spaces 8S remain. However, when the elastic member 9 is elastically deformed in the +Z direction even slightly by being urged by the protrusion portion 7, the minimum distance between the elastic member 9 and the second member 12 becomes smaller. Since the space 8S is reduced in size even if the contact portions 8C are not formed, the effect of suppressing leakage or radiation of an electromagnetic noise can be obtained to some extent.

In the example illustrated in FIG. 14A, the sectional shape of the elastic member 9 is a trapezoidal shape, and the spaces 8S (slit-shaped through hole that is inclined) for defining the elastic member 9 in the metal plate serving as a base material of the second member 12 each have a width in the X direction that is constant as viewed from any position in the Z direction. In other words, the inclined surfaces of the elastic member 9 having a trapezoidal shape defining the spaces 8S (slit-shaped through hole that is inclined) are parallel to the inner side surfaces of the second member 12. However, the fourth embodiment is not limited to this example, and the sectional shapes of the spaces 8S and the elastic member 9 can be modified in many ways.

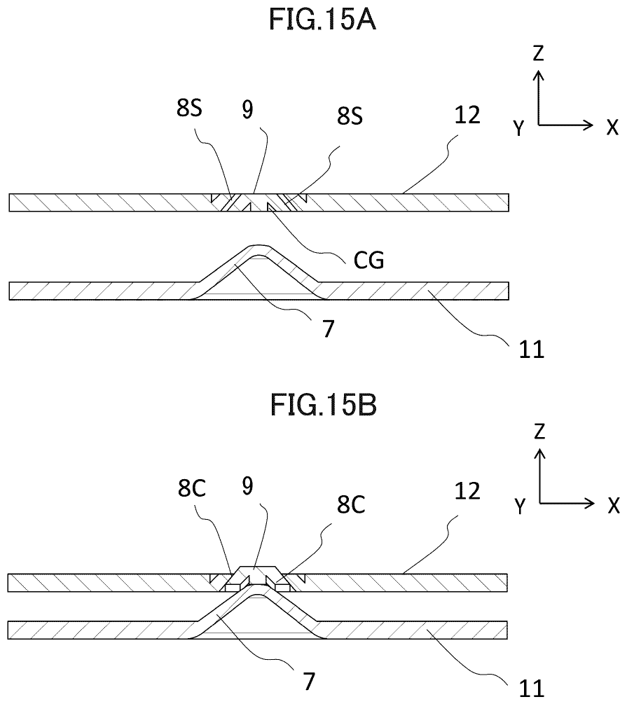

For example, the cross-section of the connection mechanism 6 along the line D-D of FIG. 2 may be in the form illustrated in FIGS. 15A and 15B. FIG. 15A illustrates the connection mechanism 6 in a state in which the lid 3 is detached from the container 2 and the two are separated, and FIG. 15B illustrates the connection mechanism 6 in a state in which the screw disposed at the fastening portion 5 is tightened and thus the lid 3 is fastened to the container 2. In this example, minute grooves CG are provided between the lower surface of the elastic member 9 and the upper surface of the second member 12. The grooves CG each may be a trace of a manufacturing step of forming the elastic member 9 and the spaces 8S that are each a slit-shaped through hole in the second member 12. The grooves CG may be formed when forming the spaces 8S by punching the metal plate, or may be formed in the processing step of punching, etching, or cutting for forming other portions. The grooves CG may have such a shape as to make the elastic member 9 more easy to deform when urged by the protrusion portion 7.

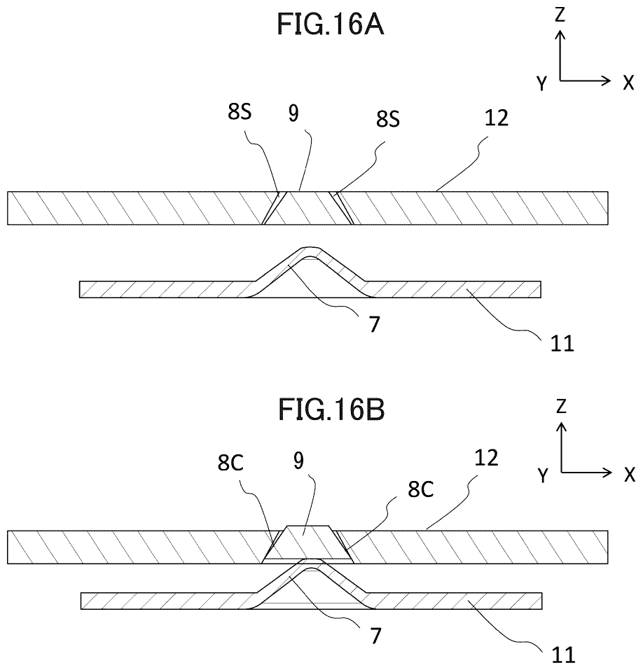

For another example, the cross-section of the connection mechanism 6 along the line D-D of FIG. 2 may be in the form illustrated in FIGS. 16A and 16B. FIG. 16A illustrates the connection mechanism 6 in a state in which the lid 3 is detached from the container 2 and the two are separated, and FIG. 16B illustrates the connection mechanism 6 in a state in which the screw disposed at the fastening portion 5 is tightened and thus the lid 3 is fastened to the container 2. In this example, the inclined surfaces of the elastic member 9 having a trapezoidal shape defining the spaces 8S (slit-shaped through holes that are inclined) are not parallel to the inner side surfaces of the second member 12. Therefore, as illustrated in FIG. 16B, the elastic member 9 elastically deformed by being urged in the +Z direction by the protrusion portion 7 abuts the inner side surfaces of the second member 12 at corner portions thereof at respective ends of the bottom base of the trapezoidal shape, and therefore the contact portions 8C are formed there. To be noted, although the inclined surfaces of the elastic member 9 having a trapezoidal shape defining the spaces 8S (slit-shaped through holes that are inclined) and the inner side surfaces of the second member 12 are inclined such that the distance therebetween in the X direction is larger at a position higher in the +Z direction in the example of FIG. 16A, this may be reversed. That is, the inclined surfaces of the elastic member 9 having a trapezoidal shape and the inner side surfaces of the second member 12 may be inclined such that the distance therebetween in the X direction is smaller at a position higher in the +Z direction. In either case, since there is a part where the distance in the X direction is small, the intensity of the electromagnetic noise that is leaked or radiated is lower also in the vicinity of end portions of the elastic member 9 in the longitudinal direction where the contact portions 8C are not formed.

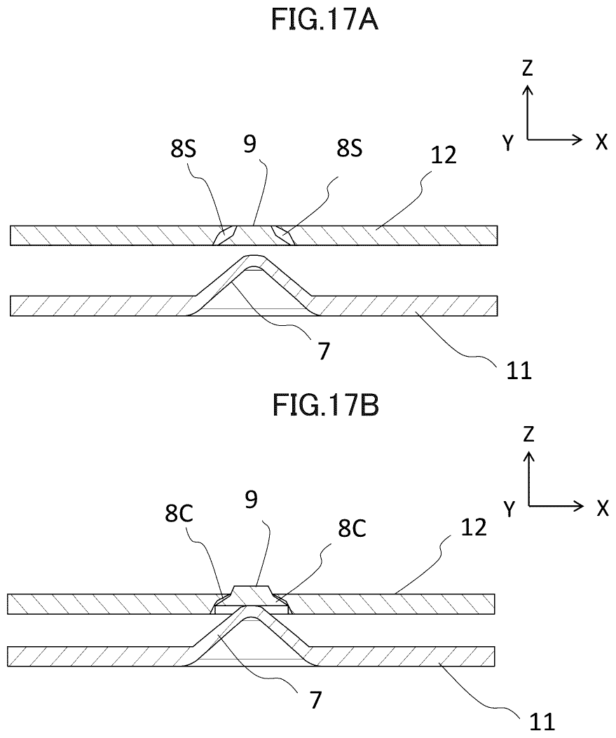

For another example, the cross-section of the connection mechanism 6 along the line D-D of FIG. 2 may be in the form illustrated in FIGS. 17A and 17B. FIG. 17A illustrates the connection mechanism 6 in a state in which the lid 3 is detached from the container 2 and the two are separated, and FIG. 17B illustrates the connection mechanism 6 in a state in which the screw disposed at the fastening portion 5 is tightened and thus the lid 3 is fastened to the container 2. In this example, the inclined surfaces of the elastic member 9 defining the spaces 8S (slit-shaped through holes that are inclined) and the inner side surfaces of the second member 12 are not flat surfaces. In other words, the spaces 8S (slit-shaped through holes) for defining the elastic member 9 each do not have a constant width in the X direction as viewed from every position in the Z direction, and the width in the X direction is the largest in the vicinity of the center portion in the Z direction. In other words, in a state in which the first member 11 and the second member 12 are not in contact with each other, the width of the space 8S increases and then decreases from the side closer to the first member 11 to the side farther from the first member 11. This shape may be dependent on the manufacturing step of forming the spaces 8S that are each a through hole by shaving the metal plate from both the front side and the back side. Since the space 8S is tapered toward both the front side and the back side of the second member 12, the intensity of the electromagnetic noise that is leaked or radiated is lower also in the vicinity of end portions of the elastic member 9 in the longitudinal direction where the contact portions 8C are not formed.

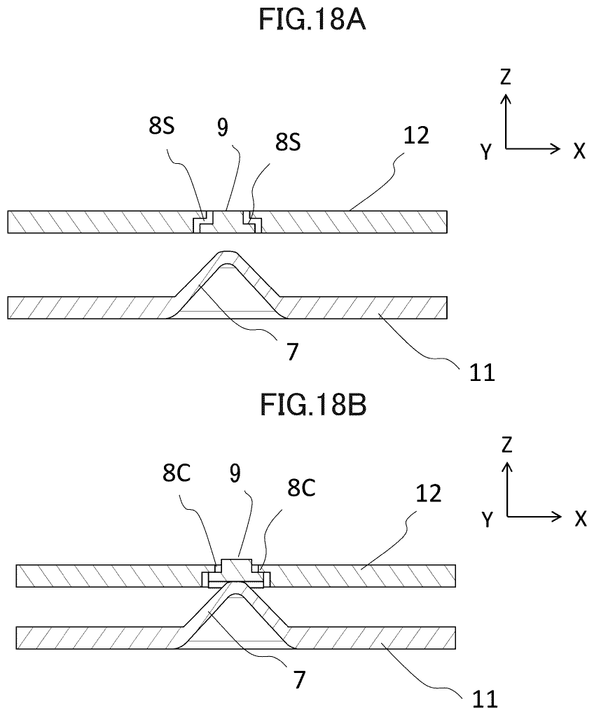

For another example, the cross-section of the connection mechanism 6 along the line D-D of FIG. 2 may be in the form illustrated in FIGS. 18A and 18B. FIG. 18A illustrates the connection mechanism 6 in a state in which the lid 3 is detached from the container 2 and the two are separated, and FIG. 18B illustrates the connection mechanism 6 in a state in which the screw disposed at the fastening portion 5 is tightened and thus the lid 3 is fastened to the container 2. In this example, side surfaces of the elastic member 9 defining the spaces 8S (slit-shaped through holes) and the inner side surfaces of the second member 12 are not flat surfaces and each has a stepped structure. Since the spaces 8S are each bent between the front side and the back side of the second member 12, the intensity of the electromagnetic noise that is leaked or radiated is lower also in the vicinity of end portions of the elastic member 9 in the longitudinal direction where the contact portions 8C are not formed.

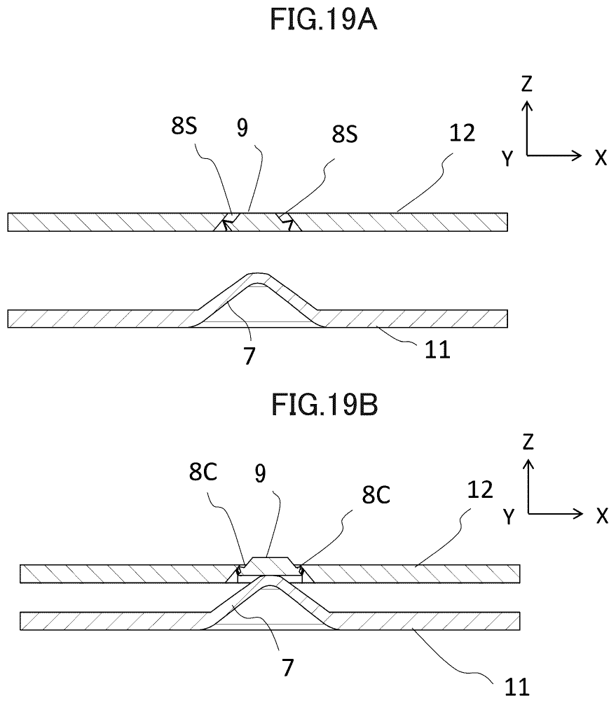

For another example, the cross-section of the connection mechanism 6 along the line D-D of FIG. 2 may be in the form illustrated in FIGS. 19A and 19B. FIG. 19A illustrates the connection mechanism 6 in a state in which the lid 3 is detached from the container 2 and the two are separated, and FIG. 19B illustrates the connection mechanism 6 in a state in which the screw disposed at the fastening portion 5 is tightened and thus the lid 3 is fastened to the container 2. In this example, a protrusion portion is formed on each side surface of the elastic member 9 defining the spaces 8S (slit-shaped through holes), and the inner side surfaces of the second member 12 are each a flat surface inclined with respect to the main surface of the second member 12. Therefore, as illustrated in FIG. 19B, the elastic member 9 elastically deformed by being urged in the +Z direction by the protrusion portion 7 abuts the inner side surfaces of the second member 12 by the protrusion portions formed on the side surfaces thereof, and therefore the contact portions 8C are formed at the positions of contact. Since the width of the spaces 8S is reduced by the protrusion portions, the intensity of the electromagnetic noise that is leaked or radiated is lower also in the vicinity of end portions of the elastic member 9 in the longitudinal direction where the contact portions 8C are not formed.

According to the present embodiment and the modification examples thereof, when fastening the lid 3 to the container 2, the elastic member 9 is urged by the protrusion portion 7 to be elastically deformed in the +Z direction. As a result of this, in the vicinity of the protrusion portion 7, the contact portions 8C are formed by abutment between the elastic member 9 and the second member 12, and the spaces 8S are no longer present. As viewed in the longitudinal direction of the elastic member 9, as illustrated in FIG. 13, the spaces 8S still remain in the vicinity of the end portion, but as a result of the elastic deformation of the elastic member 9, the spaces 8S are greatly reduced in size near the contact portions 8C. As described above, the spaces 8S possibly serving as a path through which an electromagnetic noise is leaked or radiated from the inside of the casing 1 to the outside are greatly reduced in size in a state in which an electric conduction path is established between the lid 3 and the container 2.

The length of the spaces 8S in the Z direction (that is, the distance between the second member 12 and the elastic member 9) in a state in which the protrusion portion 7 is not urging the elastic member 9 may be equal to or less than a distance by which the elastic member 9 is urged by the protrusion portion 7 in the +Z direction when fastening the lid 3 to the container 2. This is because if the length of the space 8S in the Z direction is larger than this, there is a possibility that the contact portions 8C are not formed even right above the protrusion portion 7 when the protrusion portion 7 urges the elastic member 9, and the spaces 8S remain. However, when the elastic member 9 is elastically deformed in the +Z direction even slightly by being urged by the protrusion portion 7, the minimum distance between the elastic member 9 and the second member 12 becomes smaller. Since the spaces 8S are reduced in size even if the contact portions 8C are not formed, the effect of suppressing leakage or radiation of an electromagnetic noise can be obtained to some extent.

The connection mechanism 6 is disposed at a plurality of portions in the casing 1 as illustrated in FIG. 1, and therefore the reliability of the electric connection between the lid 3 and the container 2 is secured. While repeating the attachment and detachment of the lid 3 and the container 2, for example, even if the lid 3 is deformed to some extent, the elastic member 9 is elastically deformed while securing electric connection at a plurality of portions, and therefore leakage of the electromagnetic noise is suppressed.

### Fifth Embodiment

Embodiments of the present disclosure are not limited to the embodiments described above. A fifth embodiment having a different electric connection structure will be described below. To be noted, description of matter common to the first embodiment will be simplified or omitted. Description of the casing of the electronic device is substantially the same as in the first embodiment described with reference to FIG. 1. The electric connection mechanism according to the present embodiment is similar to that described in the first embodiment with reference to FIG. 2 in transparent view from obliquely above. However, the shape of the elastic member, the placement of the protrusion portion, and the like are different from the first embodiment.

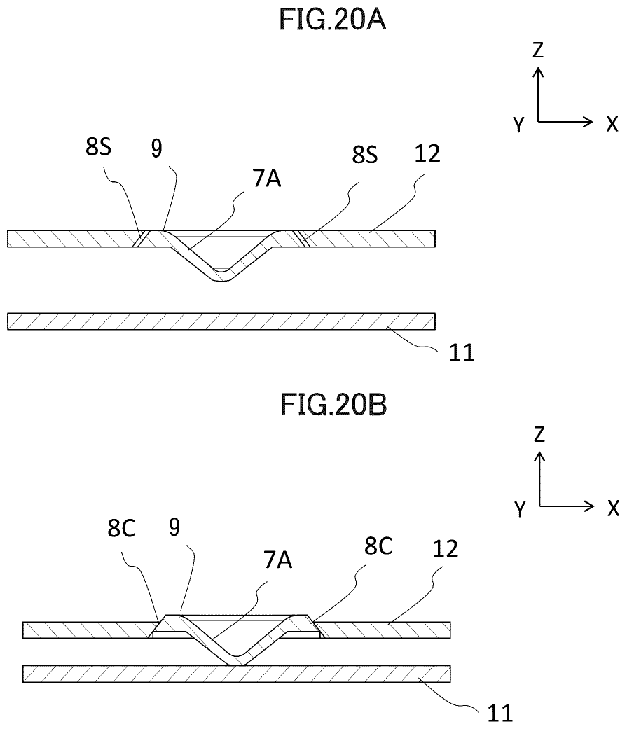

FIGS. 20A and 20B are each a section view of the connection mechanism 6 taken along the line D-D of FIG. 2. FIG. 20A illustrates the connection mechanism 6 in the state in which the lid 3 is detached from the container 2 and the two are separated, and FIG. 20B illustrates the connection mechanism 6 in the state in which the screw disposed at the fastening portion 5 is tightened and thus the lid 3 is fastened to the container 2.

### Electric Connection Structure

In each embodiment described above, the second member 12 is provided with the elastic member 9, and the first member 11 is provided with the protrusion portion 7 protruding toward the elastic member 9. Further, when the lid 3 is fastened to the container 2, the protrusion portion 7 of the first member 11 urges the elastic member 9 of the second member 12 to elastically deform the elastic member 9.

In contrast, in the fifth embodiment, as illustrated in FIGS. 20A and 20B, the first member 11 is a plate-shaped member having a flat upper surface, and is not provided with a protrusion portion protruding toward the second member 12. The second member 12 having conductivity is provided with a conductive elastic member 9 extending in the longitudinal direction thereof. That is, in the metal plate serving as a base material of the second member 12, spaces 8S that are each a slit-shaped through hole inclined with respect to the main surface is formed, and the elastic member 9 that is elastically deformable is provided. In the second member 12, the elastic member 9 may be referred to as a second portion, and a portion other than the elastic member 9 may be referred to as a first portion.

In the present embodiment, the elastic member 9 includes a protrusion portion 7A protruding in the −Z direction toward the first member 11. As illustrated in FIG. 20A, in a state in which the lid 3 is detached from the container 2 and the two are separated, the protrusion portion 7A is separated from the first member 11, and no electric conduction is established between the lid 3 and the container 2. In contrast, in a state in which the screw disposed at the fastening portion 5 is tightened and the lid 3 is fastened to the container 2, as illustrated in FIG. 20B, the protrusion portion 7A is urged in the +Z direction by the flat first member 11. As a result of this, the elastic member 9 is elastically deformed, and the two are fixed to each other in a state in which an appropriate contact force is acting therebetween. Therefore, an electric conduction path is reliably formed between the lid 3 and the container 2.

According to the present embodiment, when fastening the lid 3 to the container 2, the elastic member 9 integrated with the protrusion portion 7A urged by the first member 11 is elastically deformed, and therefore a path through which an electromagnetic noise is leaked or radiated to the outside can be narrowed. That is, according to the present embodiment, an electric connection structure capable of suppressing leakage or radiation of an electromagnetic noise to the outside is formed while reliably securing electric connection.

As illustrated in FIG. 20A, in a state in which the protrusion portion 7A integrated with the elastic member 9 is separated from the first member 11, the second member 12 is separated from the elastic member 9, and there are the spaces 8S therebetween. This space 8S is present in the entire region of the elastic member 9 in the longitudinal direction. The space 8S can serve as a path through which an electromagnetic noise is leaked or radiated from the inside of the casing 1 to the outside.

However, according to the present embodiment, when fastening the lid 3 to the container 2, the elastic member 9 is urged by the first member 11 via the protrusion portion 7A to be elastically deformed in the +Z direction. As a result of this, as illustrated in FIG. 20B, the elastic member 9 abuts the second member 12 to form the contact portions 8C, and the spaces 8S are no longer present. As viewed in the longitudinal direction of the elastic member 9, the spaces 8S still remain in the vicinity of the end portions, but as a result of the elastic deformation of the elastic member 9, the spaces 8S are greatly reduced in size near the contact portions 8C. As described above, the spaces 8S possibly serving as a path through which an electromagnetic noise is leaked or radiated to the outside from the inside of the casing 1 is greatly reduced in size in a state in which an electric conduction path is established between the lid 3 and the container 2.

The length of the spaces 8S in the Z direction (that is, the distance between the second member 12 and the elastic member 9) in a state in which the first member 11 is not urging the protrusion portion 7A may be equal to or less than a distance by which the elastic member 9 is urged in the +Z direction when fastening the lid 3 to the container 2. This is because if the length of the space 8S in the +Z direction is larger than this, there is a possibility that the contact portions 8C are not formed when the first member 11 urges the protrusion portion 7A of the elastic member 9, and the spaces 8S remain. However, when the elastic member 9 is elastically deformed in the +Z direction even slightly by being urged by the first member 11, the minimum distance between the elastic member 9 and the second member 12 becomes smaller. Since the space 8S is reduced in size even if the contact portions 8C are not formed, the effect of suppressing leakage or radiation of an electromagnetic noise can be obtained to some extent.

In the present embodiment, the casing 1 has such a structure that the inside thereof is not visible as a result of being covered by the elastic member 9 when viewed from the Z direction. Therefore, the electromagnetic noise that propagates in the +Z direction from the inside of the container 2 toward the outside of the casing 1 is shielded by the conductive elastic member 9. In addition, since the space 8S between the elastic member 9 and the second member 12 is narrowed by the elastic deformation of the elastic member 9, the electromagnetic noise leaking to the outside by passing through the spaces 8S between the elastic member 9 and the second member 12 is suppressed greatly.

The connection mechanism 6 is disposed at a plurality of portions in the casing 1 as illustrated in FIG. 1, and therefore the reliability of the electric connection between the lid 3 and the container 2 is secured. While repeating the attachment and detachment of the lid 3 and the container 2, for example, even if the lid 3 is deformed to some extent, the electric connection is secured by elastic deformation of the elastic member 9, and therefore leakage of the electromagnetic noise is suppressed.

### EXAMPLES AND REFERENCE EXAMPLES

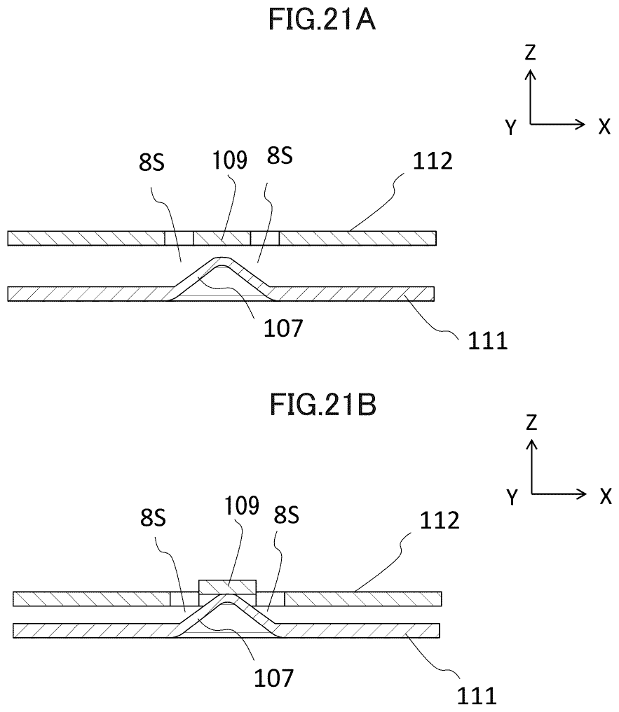

Specific examples of the embodiments will be described below. As specific examples of the first embodiment, the second embodiment, and the fourth embodiment, Examples 1 to 3 will be described. In addition, as a reference example, a connection mechanism illustrated in FIGS. 21A and 21B will be described. FIGS. 21A and 21B are each a section view of the connection mechanism according to the reference example taken along the line D-D of FIG. 2. FIG. 21A illustrates the connection mechanism in the state in which the lid 3 is detached from the container 2 and the two are separated, and FIG. 21B illustrates the connection mechanism in the state in which the screw disposed at the fastening portion 5 is tightened and thus the lid 3 is fastened to the container 2. The connection mechanism according to the reference example includes a first member 111, a protrusion portion 107, a second member 112, and an elastic member 109 electrically connected to the second member 112.

The connection mechanism described as a reference example has a structure in which the elastic member 109 that is elastically deformed does not abut the second member 112 in the state in which the lid 3 is fastened to the container 2, and therefore the contact portion 8C is not formed in the vicinity of the protrusion portion 107 unlike in the embodiments, and a large space 8S remains.

The protrusion portion 7 of Examples 1 to 3 and the protrusion portion 107 of the reference example have the same shape. In addition, the elastic member 9 of Examples 1 to 3 and the elastic member 109 of the reference example both have a length of 100 mm in the longitudinal direction.

The specifications of each portion of the examples and the reference example are as follows

### (First Member 11 and First Member 111)

Material: SECC (electrically zinc-plated steel plate)
Thickness: 0.6 mm

### (Second Member 12 and Second Member 112)

Material: SECC (electrically zinc-plated steel plate)
Thickness: 0.6 mm

The evaluation method for the examples and reference example is as follows. The connection mechanism of each of Examples 1 to 3 and the reference example was provided in the casing 1 illustrated in FIG. 1, and the amount of radiation of an electromagnetic wave leaked to the outside from the inside of the casing 1 was evaluated. In the evaluation method, an oscillator that generated a fundamental wave of 30 MHz to 1 GHz was disposed inside the casing 1, and the amount of electromagnetic wave noise was measured at a position that was 10 m from the casing 1. At the time of fastening by the fastening portion 5, the load by which the protrusion portion urged the elastic member was measured by using a load meter, and thus the relationship between the urging amount by the protrusion portion and the load was measured. At the fastening portion, the fastening was performed by using a resin screw not having conductivity.

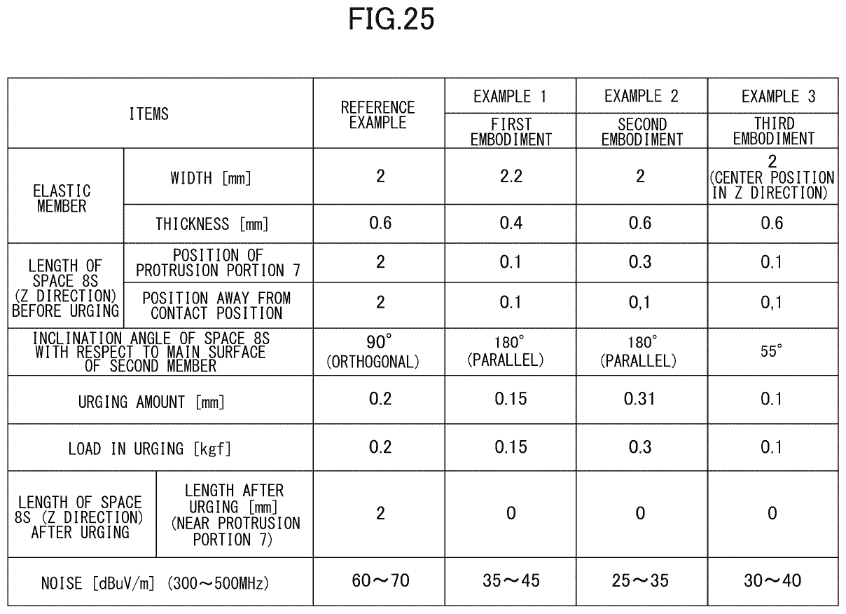

FIG. 25 illustrates a table showing specifications and evaluation results of the examples and the reference example. For Examples 1 to 3, an evaluation result that there was less noise radiation than in the reference example was obtained.

In the reference example, the protrusion portion 107 abutted and urged the elastic member 109, but the space 8S was not narrowed, and therefore the noise radiation was high in the frequency band of 300 MHz to 500 MHz. Generally, the intensity of electromagnetic noise radiation allowed in an electronic device is 60 dBuV/m or less, and the connection mechanism of the reference example did not satisfy this.

In Example 1, the elastic member 9 is elastically deformed in the +Z direction by being urged by the protrusion portion 7. As a result of this, in the vicinity of the protrusion portion 7, as illustrated in FIG. 5B, end portions of the elastic member 9 in the short-side direction abut the second member 12 to form the contact portions 8C, and the space 8S is no longer present. As viewed in the longitudinal direction of the elastic member 9, as illustrated in FIG. 4, although the space 8S remains in the vicinity of the end portions BD, the space 8S is greatly reduced in size in the vicinity of the contact portions 8C as a result of the elastic deformation of the elastic member 9. Therefore, an effect of shielding the electromagnetic noise was exerted more than in the reference example, and the noise radiation was reduced to about a half of that of the reference example.

In Example 2, the elastic member 9 is elastically deformed in the +Z direction by being urged by the protrusion portion 7. Particularly, as illustrated in FIG. 7, the elastic member 9 is elastically deformed in the +Z direction in a wide range along the longitudinal direction (Y direction) centered on the contact portions 8C. As a result of this, the space 8S is greatly reduced in size in the vicinity of the contact portions 8C. In Example 2, an effect of shielding the electromagnetic noise was exerted more than in the reference example, and the noise radiation was reduced more than in Example 1.

In Example 3, the elastic member 9 is elastically deformed in the +Z direction by being urged by the protrusion portion 7. As illustrated in FIG. 14A, the space 8S is inclined with respect to the main surface of the second member 12. As viewed in the longitudinal direction of the elastic member 9, as illustrated in FIG. 13, although the space 8S remains in the vicinity of the end portion, the space 8S is greatly reduced in size in the vicinity of the contact portions 8C as a result of the elastic deformation of the elastic member 9, and the space 8S is inclined with respect to the main surface of the second member 12. Therefore, an effect of shielding the electromagnetic noise was exerted more than in the reference example, and the noise radiation was reduced more than in Example 1.

### Modification Examples

To be noted, the present disclosure is not limited to the embodiments and examples described above, and can be modified in many ways within the technical scope of the present disclosure. For example, the entirety or part of the different embodiments and examples described above may be combined for implementation.

For example, although a configuration in which a container constituting the casing includes the first member and the lid includes the second member is employed in the embodiments described above, the casing may be formed such that the container includes the second member and the lid includes the first member.

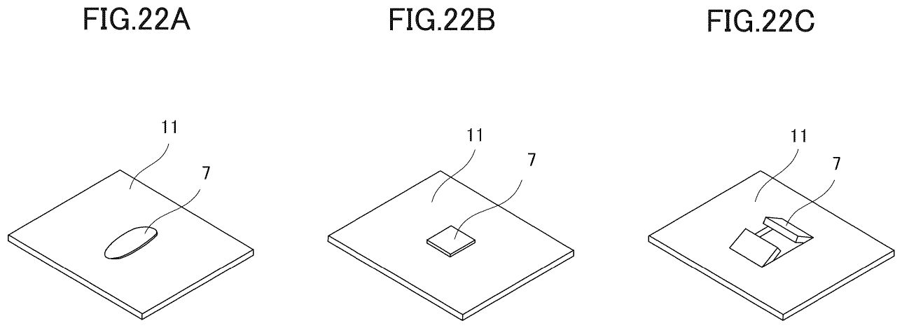

Although the first member 11 includes the protrusion portion 7 having a conical shape in the first to fourth embodiments, the protrusion portion 7 is not limited to this example. That is, the protrusion portion 7 may have any shape as long as the protrusion portion 7 is capable of elastically deforming the elastic member 9 of the second member 12 by urging the elastic member 9 and capable of establishing good electric connection by coming into contact with the elastic member 9, when the lid 3 is fastened to the container 2. For example, the protrusion portion 7 may be an elliptical cone whose horizontal cross-section has an elliptical shape instead of a circular shape as illustrated in FIG. 22A. In addition, the top portion of the protrusion portion 7 may constitute a flat surface instead of a point as illustrated in FIG. 22B, and the protrusion portion may be a prism such as a quadrangular prism or a cylinder. Alternatively, the top portion of the protrusion portion 7 may constitute a line instead of a point as illustrated in FIG. 22C. In addition, as illustrated in FIG. 22C, the protrusion portion 7 that is part peeled up from the plate may be formed by bending part of the first member 11 having a plate shape.

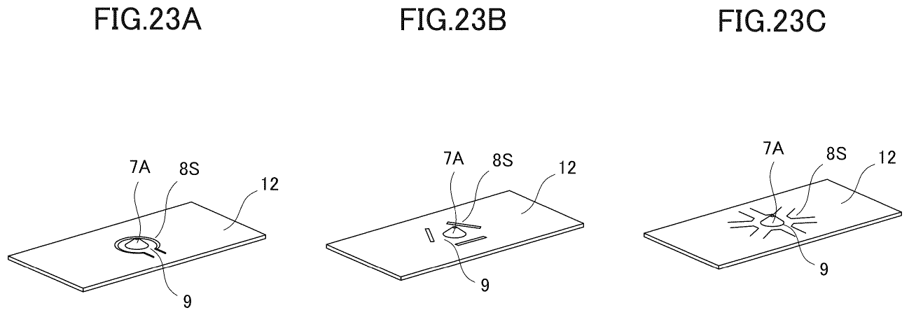

Although the second member 12 is provided with the slit-shaped spaces 8S and the protrusion portion 7A in the fifth embodiment, the configuration of the second member 12 is not limited to that illustrated in FIGS. 20A and 20B. That is, any configuration may be employed as long as when the lid 3 is fastened to the container 2, the second member 12 can transmit the urging force of the first member 11 to the elastic member 9 and come into contact with the first member 11 to establish good electric connection. For example, as illustrated in FIG. 23A, the protrusion portion 7A may be surrounded by a space 8S that is an arcuate slit such that a connecting portion between the protrusion portion 7A and the second member 12 functions as the elastic member 9. In addition, as illustrated in FIG. 23B, a configuration in which a plurality of spaces 8S that are each a linear slit are formed around the protrusion portion 7A and a portion between the protrusion portion 7A and the spaces 8S functions as the elastic member 9 may be employed. Alternatively, as illustrated in FIG. 23C, a configuration in which a plurality of spaces 8S that are each a V-shaped slit are formed around the protrusion portion 7A and a portion between the protrusion portion 7A and the spaces 8S functions as the elastic member 9 may be employed.

An electronic device to which the electric connection structure according to the present disclosure can be applied is not limited to the device of the form exemplified in FIG. 1. Examples of the electronic device include various office appliances such as personal computers and copiers, various home appliances, various manufacturing apparatuses such as processing machines, control apparatuses that control various devices, and communication devices, and the kinds thereof are not particularly limited.

The casing to which the electric connection structure according to the present disclosure can be applied is not limited to the casing 1 constituted by a container and a lid as exemplified in FIG. 1. The casing can be in various forms according to the use of the electronic device. In addition, the electric connection structure according to the present disclosure can be also applied to a container or a casing accommodating arbitrary electronic parts. The electric connection structure according to the present disclosure can be applied to any structure as long as the structure establishes electric conduction by fastening two conductive members superimposed on each other to each other.

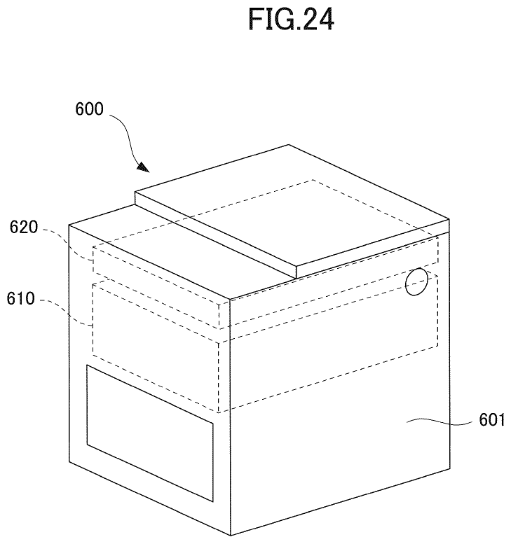

For example, the casing of an image forming apparatus having an exterior as illustrated in FIG. 24 may be employed. An image forming apparatus 600 is, for example, a laser beam printer of an electrophotographic system. The image forming apparatus 600 includes an exterior cover 601, and an image forming portion 610 and an image reading portion 620 that are accommodated in the exterior cover 601. The image reading portion 620 is an apparatus that reads an image of a set document. The image forming portion 610 forms an image on a sheet on the basis of image data. Examples of recording media that can be the sheet include paper sheets such as plain paper sheets, special paper sheets like coated paper sheets, envelopes, and index paper sheets, plastic films for overhead projectors, and cloths. A plurality of members are detachably or openably and closably fastened to the exterior cover 601 of the image forming apparatus 600, and the electric connection mechanism according to the present disclosure can be used between these members to suppress an electromagnetic noise radiated from the image forming apparatus 600.

According to the present disclosure, a technique capable of suppressing leakage or radiation of an electromagnetic noise to the outside while reliably securing electric connection can be provided.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-134499, filed Aug. 9, 2024, which is hereby incorporated by reference herein in its entirety.

What is claimed is:

1. An electric connection structure comprising:
a first member having conductivity; and
a second member having conductivity and including a first portion and a second portion that is elastically deformable,
wherein in a state in which the first member and the second member are not in contact with each other, the second portion and the first portion are separated from each other with a space therebetween, and a minimum distance between the second portion and the first portion is a first distance, and
wherein in a state in which the first member and the second member are in contact with each other, the second portion is elastically deformed, and the minimum distance between the second portion and the first portion is a second distance smaller than the first distance.

2. The electric connection structure according to claim 1, further comprising a fastening portion capable of fastening the first member and the second member together in contact with each other.

3. The electric connection structure according to claim 1, wherein in the state in which the first member and the second member are in contact with each other, the second portion is elastically deformed, and at least part of the second portion abuts the first portion.

4. The electric connection structure according to claim 1, wherein in the state in which the first member and the second member are in contact with each other, at least part of the second portion abuts the first portion at a position near a position where the first member and the second member are in contact with each other as viewed in a longitudinal direction of the first member.

5. The electric connection structure according to claim 1, wherein in the state in which the first member and the second member are not in contact with each other, the space is a space inclined with respect to a thickness direction of the second member.

6. The electric connection structure according to claim 1, wherein in the state in which the first member and the second member are not in contact with each other, a width of the space is constant.

7. The electric connection structure according to claim 1, wherein in the state in which the first member and the second member are not in contact with each other, a width of the space is larger at a portion closer to the first member.

8. The electric connection structure according to claim 1, wherein in the state in which the first member and the second member are not in contact with each other, a width of the space is smaller at a portion closer to the first member.

9. The electric connection structure according to claim 1, wherein in the state in which the first member and the second member are not in contact with each other, the space is bent.

10. The electric connection structure according to claim 1, wherein in the state in which the first member and the second member are not in contact with each other, a width of the space increases and then decreases from a side closer to the first member to a side farther from the first member.

11. The electric connection structure according to claim 1, wherein a sectional shape of the second portion in section view of the second member taken along a short-side direction of the second member is a trapezoidal shape.

12. The electric connection structure according to claim 1, wherein a sectional shape of the second portion in section view of the second member taken along a short-side direction of the second member has a protrusion portion protruding toward the first portion.

13. The electric connection structure according to claim 1, wherein the second portion has a groove formed along a longitudinal direction of the second member.

14. The electric connection structure according to claim 1, wherein the first member includes a protrusion portion, and the protrusion portion is in contact with the second portion in the state in which the first member and the second member are in contact with each other.

15. The electric connection structure according to claim 1,
wherein the second member includes a protrusion portion,
wherein the second portion is disposed between the protrusion portion and the first portion, and
wherein in the state in which the first member and the second member are in contact with each other, the protrusion portion is in contact with the first member.

16. The electric connection structure according to claim 1, wherein in a state in which the first member and the second member are fastened together in contact with each other, an end portion of the second portion in a short-side direction abuts the first portion.

17. The electric connection structure according to claim 1,
wherein the first portion has an opening, and
wherein as viewed in a direction in which the first member and the second member are pressed, the opening overlaps with the second portion.

18. The electric connection structure according to claim 1, wherein the first member and the second member are members constituting a casing of an electronic device.

19. An electronic device comprising:
the electric connection structure according to claim 1,
wherein the first member is a container configured to accommodate an electronic part, and the second member is a lid of the container.

20. An electronic device comprising:
the electric connection structure according to claim 1,
wherein the first member and the second member each constitute part of a casing.
